(19) United States
(12) Patent Application Publication
(10) Pub. No.: US 2011/0309662 A1
(43) Pub. Date: Dec. 22, 2011

(54) SYSTEM OF SEATS FOR MEANS OF TRANSPORT

(76) Inventor: Alberto Veneruso, Napoli (IT)

(21) Appl. No.: 13/145,556

(22) PCT Filed: Jan. 21, 2010
(86) PCT No.: PCT/IB10/50271

§ 371 Date: Sep. 7, 2011

(30) Foreign Application Priority Data
Jan. 23, 2009 (IT) RM2009A000025

(51) Int. Cl. B60N 2/34; B61D 31/00; B61D 33/00; B64D 11/06; B63B 17/00

(52) U.S. Cl. 297/232; 244/118.6

(57) ABSTRACT

A system of seats is described to be used on any transportation means, e.g. aircraft, train or ship, in order to offer a high level of comfort to passengers, concomitantly reducing the encumbrances associated to such seats and thereby allowing to provide a higher number of seats, available cabin space being equal, at competitive prices. The system of seats available space being equal when compared to a typical first-class installation, makes available plural seats, concomitantly maintaining an equal level of comfort.

The present invention refers to a system of seats to be used on any transportation means, like e.g. an aircraft, a train or a ship, in order to offer a high level of comfort to passengers, concomitantly reducing the encumbrances associated to such seats and thereby allowing to provide a higher number of seats, available cabin space being equal, with respect to known arrangements of seats.

### HISTORY OF THE TECHNOLOGY

As is known, the arrangement of seats inside transportation vehicles, like, e.g., aircrafts, trains, buses and ships, is conditioned by the space available inside the cabin of the vehicle itself, or is configured in order to obtain a compromise between the space allowed to a single passenger and the comfort he/she enjoys in connection with said space.

Given a certain cabin length, the installable number of seats basically depends on the minimum distance between two subsequent seats, in order to provide sufficient space' for a passenger's legs.

### DESCRIPTION OF THE PRIOR ART

To date, luxury cabins (for which passengers pay a ticket surcharge), are provided with considerable space between any two seats. Of course, in these cases the additional space present between one seat and another determines greater passenger comfort. In some cases, like e.g. on aircrafts for first-class seats, the distance between two consecutive seats is big enough to enable a passenger to lie down in a manner practically parallel to the treadable floor of the aircraft, thanks to suitable mechanisms of the seat itself by which said seat can go from the standard upright seat-like configuration to a extended configuration, on which the passenger can lie down. Thus, above all during lengthy travels (more than 3-4 hours) the passenger can lie down and optionally sleep.

Pat. Appln. N° US2003/0030306, to Raczkowski, in order to solve the space-saving problem while concomitantly guaranteeing to passengers a comfort peculiar to luxury cabins, describes a system of seats arranged in rows wherein each seat exhibits the option of assuming, according to needs, an upright configuration and a substantially horizontal configuration.

In particular, the system taught is composed of seats consecutive thereamong, wherein each set of three seats has a central seat equipped with means apt to raise it with respect to the other two, in a manner such as to arrange all three seats in a substantially horizontal configuration, preventing them from interfering with each other.

### DRAWBACKS OF THE PRIOR ART

With regard to the solution proposed in the above-mentioned Patent Application US2003/0030306, although the proposed solution contributes to save space along the row itself in the horizontal direction, the fact that all seats are oriented in the same sense entails that in order to prevent interferences when in the horizontal configuration the middle seat has to be raised by a considerable amount, thereby entailing a remarkable increase of encumbrances in the vertical direction.

In general, it will be appreciated that, when the seat is set in the extended configuration, the angle measured between it and the treadable floor strongly determines the actual comfort felt by the passenger: the greater the angle, the greater the tilt of the seat in the extended configuration with respect to the treadable floor, and the more the passenger will tend to slide down toward the floor during the travel, thereby diminishing his/her wellbeing.

In seat installations generally indicated as first-class, the remarkable distance between two consecutive seats allows seats themselves to assume a substantially horizontal extended attitude, which evidently is to the advantage of a passenger's wellbeing. Obviously, a reduction in available seats, and therefore ultimately of the “paying” space in the transportation means, is compensated for by a surcharge, at times remarkable, of the ticket price.

Typically, in Business-type classes, though passengers can avail themselves of seats capable of assuming a substantially extended attitude, the more limited distance existing between two consecutive seats makes the above-mentioned angle too big to obtain an optimal level of comfort.

It will be appreciated that the level of comfort allowed to passengers in those classes is obtained as a compromise between the space between two consecutive seats, whose increase evidently reduces the number of installable seats, and the angle of the seat when extended, which determines passenger comfort and is linked just to said space provided between two consecutive seats.

### OBJECTS OF THE INVENTION

Object of the present invention is to solve the above-mentioned drawbacks by providing a system of seats as substantially described in claim 1, and a transportation means as substantially described in claim 12.

Further features of the process are defined in the corresponding dependent claims thereof.

### ADVANTAGES OF THE INVENTION

The present invention, by overcoming the mentioned problems of the known art, entails several relevant advantages.

The system of seats subject of the present invention, as will be detailed hereinafter, is such as to give to the seats, when extended, an angle equivalent to that obtained in a first class, reducing however the distance between two consecutive seats.

Therefore, the technical problem addressed and solved by the present invention is to provide a system of seats that, available space being equal when compared to a typical first-class installation, be such as to make available a greater number of seats while concomitantly maintaining an equal level of comfort, and such as to save space both in the horizontal direction and in the vertical one, thereby increasing the compactness of the interiors.

### BRIEF DESCRIPTION OF THE DRAWINGS

Still further advantages, as well as the features and the operation modes of the present invention will be made evident in the following detailed description of a preferred embodiment thereof, given by way of example and not for limitative purposes, making reference to the figures of the annexed drawings, wherein:

FIG. 1 shows in a side view arrangements of seats according to the known art;

FIGS. 2, 3 and 5 show in a side view a system of seats according to the present invention; and

FIG. 4 shows in a side view a comparison between the arrangements of seats according to the known art and the system of seats according to the present invention;

### DETAILED DESCRIPTION OF THE DRAWINGS

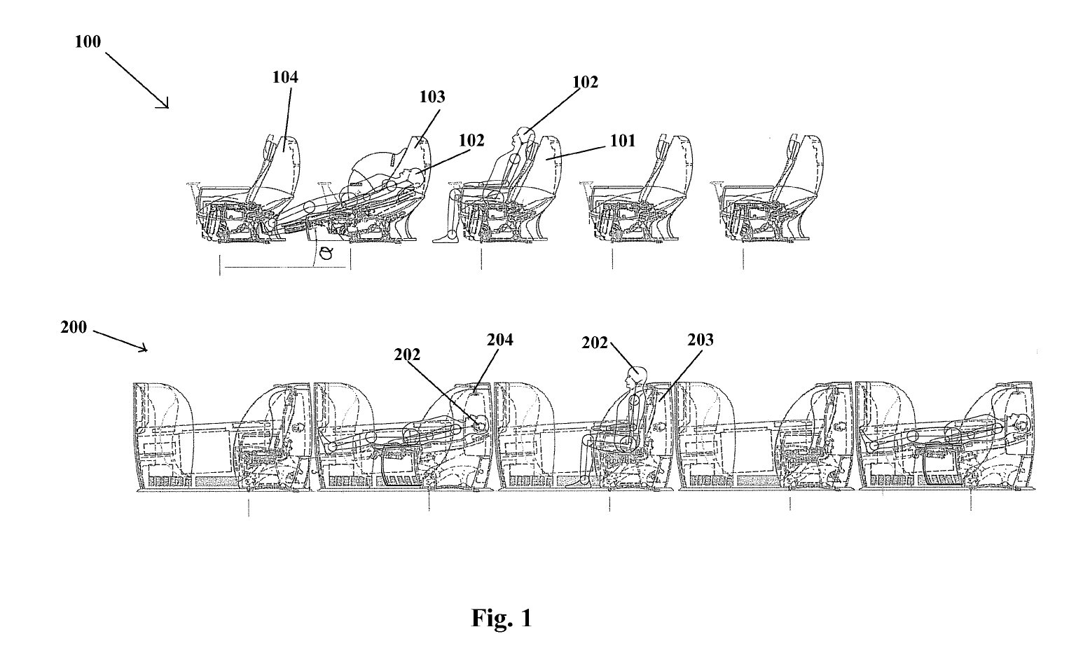

Referring to FIG. 1, a first arrangement 100 and a second arrangement 200 of seats according to the known art are depicted in a side view.

In particular, the arrangement 100 is generally used on Business-type classes, whereas the arrangement 200 is for first classes. The level of comfort offered by an arrangement of seats belonging to a Business-type class is intermediate between the first-class one, denoted by reference number 200, and an economic class (not depicted).

For both arrangements there are depicted, by way of example, a set of five seats consecutively placed in a row. The seat arrangement 100 comprises, by way of example, seats 101 and 103 taken by a passenger 102. The seat 101 has the option of being reclined, as shown by seat 103. Always referring to the arrangement 100, the seat 103 has a distance from a subsequent seat 104 such as to allow it to be tilted to the maximum, forming an angle θ with respect to a treadable floor 105.

Usually, for Business-type classes, such a distance is in the neighbourhood of 147 cm. The distance is measured between two identical points of the two seats. Said distance is such as to let the angle θ assume sensible values at about 11°. With such a tilt, gravity has a non-negligible effect on the passenger 102 who therefore tends to slide toward the floor during the travel, thereby compromising his/her wellbeing. The first-class arrangement 200 solves this problem by increasing the distance between two consecutive seats. Thus, a passenger 202 sitting on a seat 203 has the option of laying down in a substantially horizontal position, as shown by a subsequent seat 204. Generally the distance between two seats belonging to the arrangement 200 is in the neighbourhood of 203 cm. As clearly indicated in FIG. 1, showing a comparison between arrangements 100 and 200, the increase in the distance between first-class seats allows the passenger to lie down in a substantially horizontal position, yet at the same time it entails a considerable increase in the encumbrance and therefore, overall size of the travel cabin being equal, a lower number of seats with respect to the arrangement 100. This ultimately has repercussions on the price increase for the reserving of first-class seats.

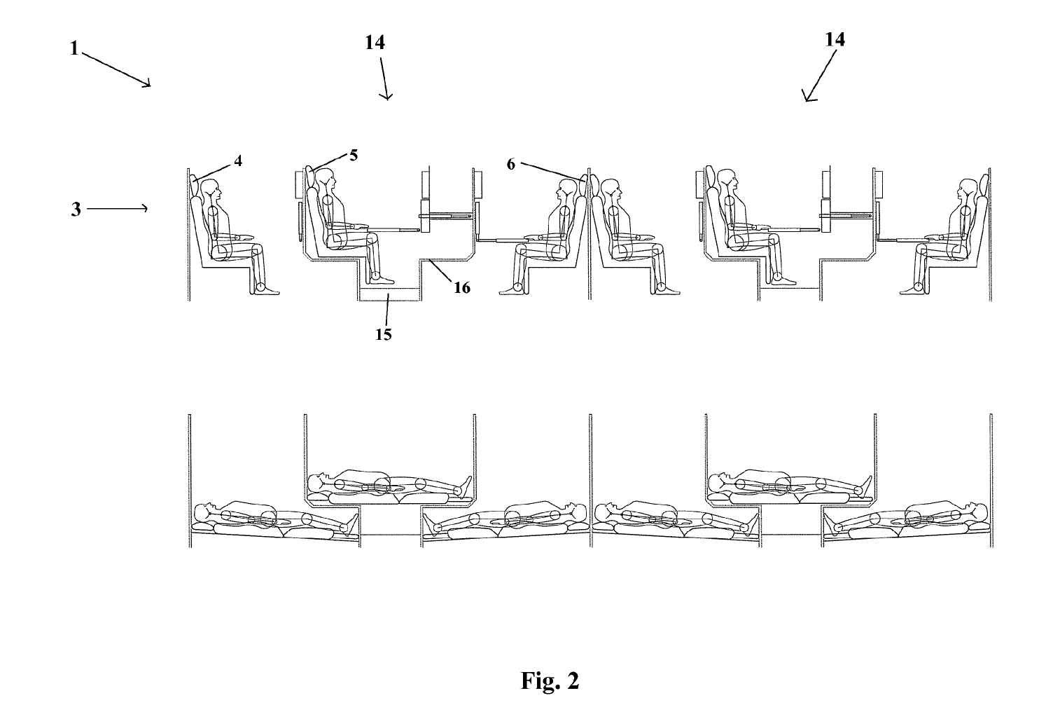

Referring now to next FIG. 2, a system 1 of seats according to the present invention is shown. The system 1 comprises seats that are arranged along a row 3. It will be appreciated that the system 1 could comprise plural rows of seats set side-by-side therebetween depending on the transversal development of the transportation means. The transportation means to which reference is made in the present detailed description is, by way of example and not for limitative purposes, an aircraft, yet it will be appreciated that the present invention could refer to any passenger transportation means, like, e.g., a train or a ship.

In particular, the row 3 comprises one or more modules 14 of seats preferably arranged consecutively the one to the other; in particular, two modules are depicted in the example in the Figure, yet it is evident that they will be in a number such as to occupy all available space.

The module 14 comprises a first seat 4, a second central seat 5 arranged subsequent to the seat 4 and in the same sense of the latter, and a third seat 6 arranged subsequent to the central seat 5 but in a sense opposite with respect to the seat 4. Always referring to FIG. 2, each seat is apt to assume a first upright configuration and a second substantially horizontal configuration, the arrangement being such that the central seat 5 is partially overlapped to the seats 4 and 5 when all three seats lie in the substantially horizontal configuration. For this purpose, the central seat 5 is set, by a step 15, in a raised position with respect to the other two seats 4 and 6 of the module 14. The central seat 5 is preferably housed inside a mushroom-like structure 16, having two bottom recesses thanks to which a space is obtained, needed to bring the two seats 4 and 5 in a substantially horizontal configuration, set below the central seat 5.

Moreover, it will be appreciated that the seat 5 could alternatively occupy the opposite side of the mushroom-like structure (a variant not illustrated) and be therefore arranged in a sense opposite to the seat 4 and concordant with the seat 6, in an entirely equivalent manner.

Each seat is equipped with means for its motion, apt to bring it from the upright configuration to the substantially horizontal configuration and vice versa, or in a position intermediate between those two configurations, depending on the passenger's needs. Such motion means could be manually operated or comprising a servomechanism. The technical contrivances and the knowledge required for their practical implementation are deemed to be within the reach of a person skilled in the art, therefore a detailed description thereof will be omitted.

The modules constituting each row are all identical thereamong and comprised of three seats, as described in detail above.

However, it will be appreciated that the length of the cabin could be not exactly equal to an integer multiple of the length of a single module.

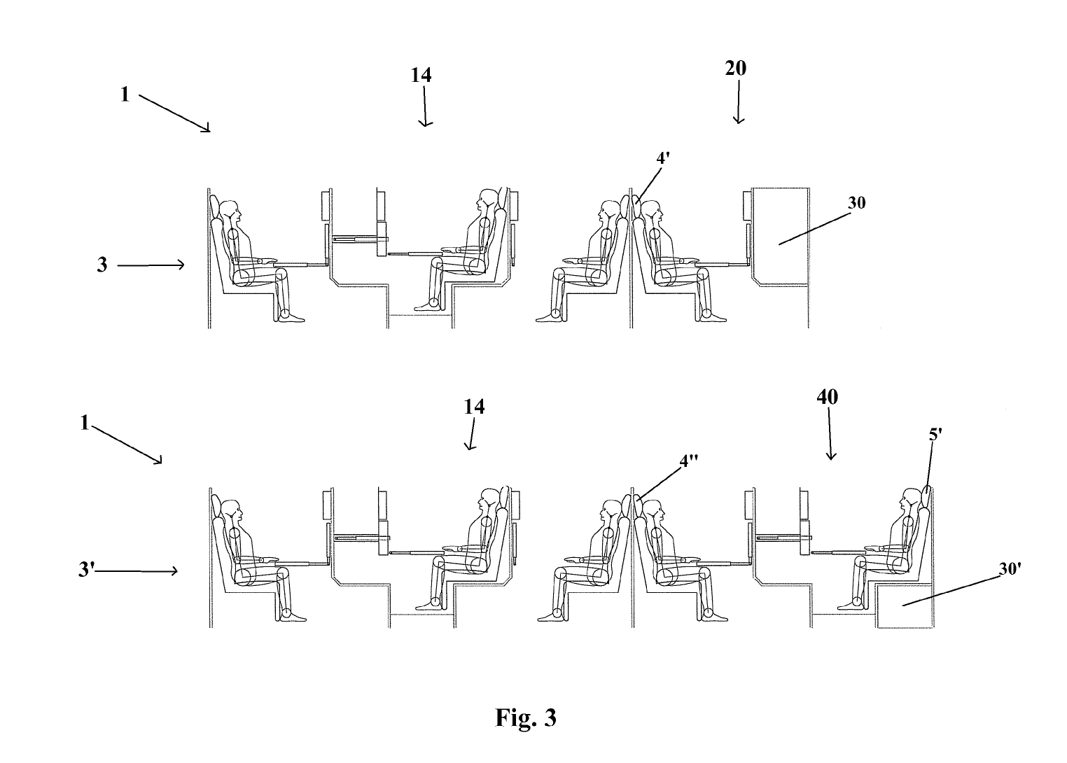

Referring to FIG. 3, a row 3 is shown, having an end module 20 which comprises a seat 4′ and a housing 30. The housing 30 may be exploited as service storage, in order to use all of the space available inside the transportation means. The housing is partially overlapped to the seat 4′, when the latter is in the substantially horizontal configuration (a situation not shown in the Figure).

Alternatively, should the residual space be even greater than that exploitable by the end module 20, the row 3 could have an end module 40 comprising a first end seat 4″ and a second end seat 5′ placed in a sense opposite to the first end seat 4″. The end module 40 is in all equal to the module 14, except that the former has one seat less, evidently owing to lack of space. In this case as well, the end seat 5′ could be positioned on the opposite side of the mushroom-like structure inside which it is contained, and therefore positioned in the same sense of the seat 4″ (a variant not shown in the Figure). Moreover, the mushroom-like structure in which the second end seat 5′ is set makes available bottomwise a second housing 30′, in the case shown in the Figure placed below the seat 5′ and that can it also be exploited as service storage. Therefore, analogously to what has been described hereto, the second end seat 5′ is positioned in a manner such as to be partially overlapped to the seat 4″ when both are set in a substantially horizontal configuration.

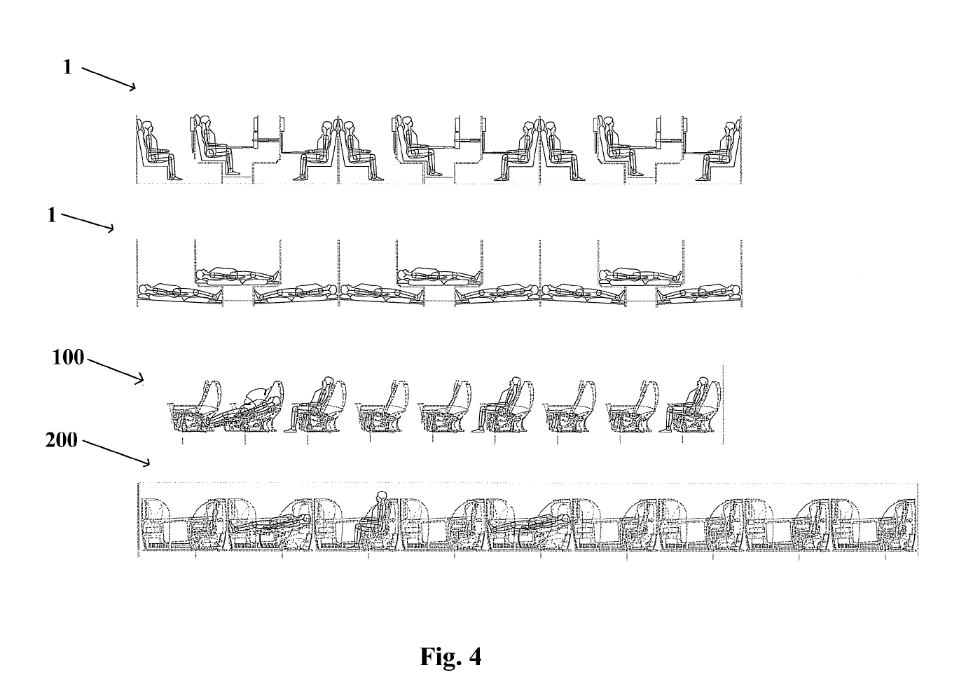

Referring to FIG. 4, there are compared the row of seats 1 according to the present invention, shown both with the seats in an upright configuration and with the seats in a substantially horizontal configuration, the row of seats 100 belonging to the Business-type class and the row of seats 200 belonging to the first class. All rows of seats shown in the Figure have the same number of seats. As is evident, the row of seats 1, in spite of having an encumbrance substantially equal to the encumbrance related to row 100, offers a higher level of comfort to passengers as it allows seats to assume a substantially horizontal configuration, in the same manner of the row 200 but the latter with a sensible increase of space used. Therefore, such an encumbrance decrease is due to the obtained partial overlapping, existing between the seats of the single module; in the specific embodiment, shown here by way of example and not for limitative purposes, having raised the central seat with respect to the other two and having positioned it inside the mushroom-like structure, which has two bottom recesses in which the two side seats are partially inserted, as clearly shown in the Figure.

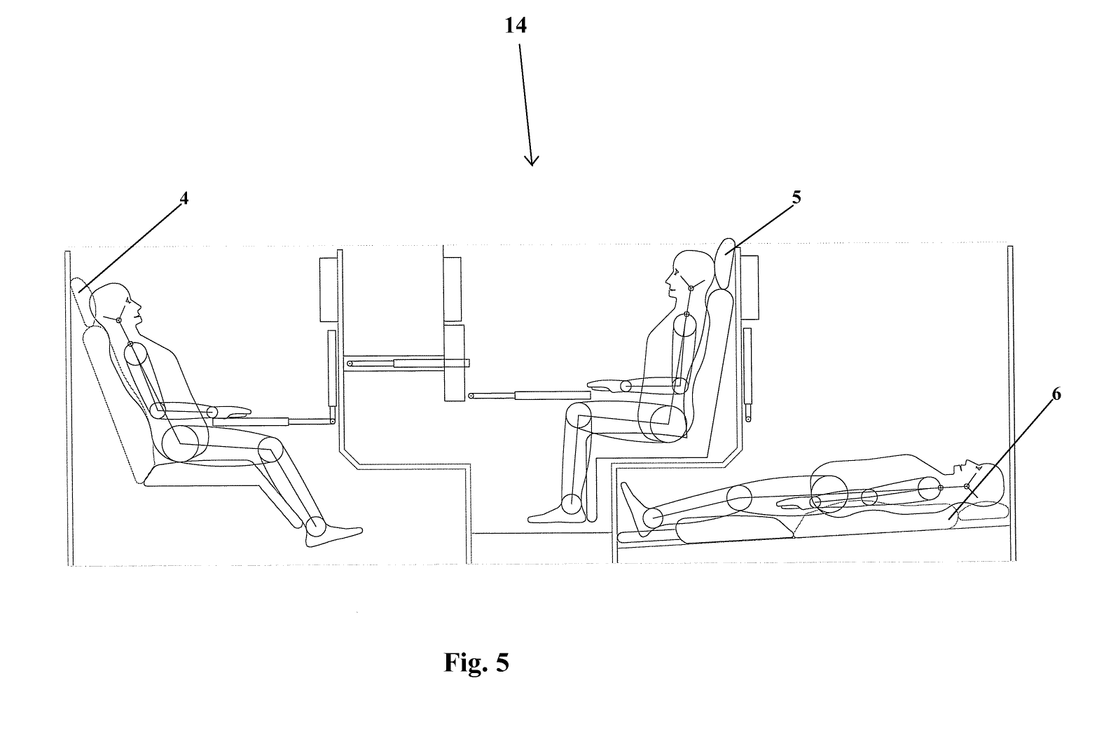

Finally, referring to the last FIG. 5, the module 14 is shown having the three seats 4, 5, 6 set in configurations different thereamong in an entirely independent manner, depending on the passenger's will. In particular, the seat 5 is placed in the upright configuration; the seat 6 is placed in a substantially horizontal configuration, whereas the seat 4 is placed in a configuration intermediate among the former and latter configurations.

The present invention has been hereto described with reference to a preferred embodiment thereof. It is understood that other embodiments might exist, all falling within the concept of the same invention and all falling within the protective scope of the claims hereinafter.

1. A system of seats of a transportation means, said seats being arranged along one or more rows, each row comprising one or more modules of seats, each module comprising:
a first seat;
a second central seat, arranged subsequent to said first seat, in the same sense of said first seat or in a sense opposite thereto;
a third seat arranged subsequent to said central seat;
each seat of said first, central and third seats being adapted to assume a first upright configuration and a second substantially horizontal configuration,
wherein the seats are arranged in a way that said central seat is at least partially overlapped to said first and third seats when said three seats are set in the substantially horizontal configuration; and
wherein said third seat is arranged in a sense opposite with respect to said first seat.

2. The system of seats according to claim 1, wherein at least when said central seat is placed in the substantially horizontal configuration, said central seat is in a raised position with respect to said first seat and said third seat.

3. The system of seats according to claim 1, wherein each seat of the first, central and third seats comprises respective means for its motion, said means being adapted to bring said each seat from said upright configuration to said substantially horizontal configuration and vice versa, or to an intermediate position therebetween.

4. The system of seats according to claim 3, wherein said motion means is manually operated.

5. The system of seats according to claim 3, wherein said motion means comprises a servomechanism.

6. The system of seats according to claim 1, wherein at least one of the one or more rows comprises an end module.

7. The system of seats according to claim 6, wherein said end module comprises a seat and a housing.

8. The system of seats according to claim 7, wherein said housing is at least partially overlapped to said seat when said seat is in the substantially horizontal configuration.

9. The system of seats according to claim 6, wherein said end module comprises a first end seat and a second end seat, arranged subsequent to said first end seat in the same sense of said first end seat or in a sense opposite thereto,
wherein when said first end seat and second end seat are set in the substantially horizontal configuration, said second end seat is at least partially overlapped to said first end seat.

10. The system of seats according to claim 9, wherein at least when said second end seat is arranged in the substantially horizontal configuration, said second end seat is in a raised position with respect to said first end seat.

11. The system of seats according to claim 1, wherein said transportation means is an aircraft.

12. A transportation means comprising a system of seats according to claim 1.
